(19) United States
(12) Patent Application Publication
(10) Pub. No.: US 2013/0104717 A1
(43) Pub. Date: May 2, 2013

(54) MITRE SAW

(71) Applicant: Samuel Ryan Rees, South Yorkshire (GB)

(72) Inventor: Samuel Ryan Rees, South Yorkshire (GB)

(73) Assignee: EVOLUTION POWER TOOLS LIMITED, South Yorkshire (GB)

(21) Appl. No.: 13/700,069

(22) PCT Filed: May 25, 2011
(86) PCT No.: PCT/IB2011/052270

§ 371 Date: Nov. 26, 2012

(30) Foreign Application Priority Data
May 27, 2010 (GB) 1008829.2

(51) Int. Cl. B23D 47/02; B23D 47/04; B23D 45/04

(52) U.S. Cl. CPC B23D 47/02; B23D 45/042; B23D 47/04
USPC 83/468.7; 83/477; 83/471

(57) ABSTRACT

A mitre saw (1) has a base (2) adapted to support a screwless workpiece clamp (12), with clamping force being adjustable, under the manual control of the operative. The underside of the base (2) is provided with formations for the attachment of legs (15). A satellite stand (17) is detachable from the base (2) and locatable by the user at a selected distance from the base (2) suitable for supporting an end of a workpiece (13) to be cut. An end stop (21) is slidably attached to the base (2) and has a rapid coarse positional adjustment feature (23), and also a fine positional adjustment feature (24). The mitre saw (1) has a support assembly (4) attachable to the base unit (2) by a hand-operable, tool free connection; and a saw assembly including an electric drive motor, which saw assembly is attachable to the saw support assembly (4) by a hand-operable, tool free connection.

### FIELD OF THE INVENTION

This invention relates to a mitre saw of a portable or semi-portable kind and including an electric motor to power a rotary saw blade.

### BACKGROUND OF THE INVENTION

Mitre saws of the above described general kind (c.f. US 2002/0144405, US 2004/0134076) are in extensive use, but most designs suffer a number of disadvantages.

For instance a base is provided with an array of apertures to receive a lower end of a mounting post of an attachment, such as a clamp for the stock/workpiece to be cut, and conventional clamps usually require a first coarse adjustment and securing by a screw means in an initial clamping position, with a need to then operate second screw means to attain a final clamping position. The result is that clamps currently available are frequently discarded, due to the time required to set up, with such non-use resulting in a safety hazard.

In addition, a clamp having the capacity to secure a full range of anticipated workpiece sizes is frequently located in a position in which it is fouled when the blade assembly is necessarily pivoted to one side as is necessary when a bevelled cut is required, leading to the need to remove the clamp such that the workpiece can only be held in place by hand, with attendant hazard, as stock clamping at the other side of the base is not always possible.

In addition, it is clearly convenient to operate a mitre saw at waist height, which requires location of the base on a bench or other elevated support surface. Such a surface frequently does not exist on say a building site so that, inconveniently, both setting up and cutting operations are carried out at floor level.

Also, a handgrip that is conventionally provided on a blade guard is frequently handed, typically so that a left-handed operator is inconvenienced. An in-line pistol, grip handle is known (GB 2438285) with a view to avoiding a saw being “handed” for gripping by one hand, with an integrated on-off trigger, but a one-handed pistol grip provides limited assistance in steadying a mitre saw, particularly if awkward cutting operations are involved.

For the cutting of relatively long workpiece that extends beyond the base, some form of support is desirable for the end of the workpiece distal from the saw if a true cut is to be maintained. On a building site with the saw at ground level, a house brick or a stack of bricks, if available, is conventionally used for such support, but bricks, being of finite dimensions, rarely provide support at an optimum height, whilst a stack is unstable.

Also, an end stop is conventionally provided so that once set in position, repeat cutting of batches of workpieces of the same length, may readily be effected. However, known end stops frequently consist of a rudimentary “U”-shaped wire stirrup projecting radially from one side of the base, or two such stirrups located at 180° spacing. Such a stirrup provides only for coarse positional adjustment, with the stop being tapped by the user towards, or away from the base, within limits, until the desired position is attained for the length to which the workpiece is to be repeatedly cut.

In addition, the end stop has a minimal inner setting so that if workpiece is required to be cut to a length shorter than this minimal setting, then the end stop cannot be used.

Finally, the awkward bulk of a mitre saw presents problems for both cartoning, handling and shipping with the cartons requiring significant packing and usually with but six cartons stackable on a single pallet.

### Object of the Invention

A basic object of the present invention is the provision of an improved mitre saw.

### Summary of a First Aspect of the Invention

According to a first aspect of the invention there is provided a mitre saw having a base adapted to support a screwless workpiece clamp, characterised in that clamping force is adjustable, under the manual control of the operative.

### Advantages of the First Aspect of the Invention

The provision of a screwless clamp ensures not only rapid clamping of a workpiece to the base of the mitre saw, which encourages use of the clamp and hence greater safety for the operator, but also enables the clamping force to be set, by the operative between a minimum and a maximum to suit the cutting operation being performed.

### Preferred or Optional Features of the First Aspect

The clamp comprises an upright support post adapted to be located in a suitable aperture in a base of the saw.

A clamp body is connected in a user-adjustable position e.g. by means of a thumb screw, on the support post and extends laterally from the support post.

Distal from the support post an upright jaw post passes through the clamp body and also through a grab plate housed within the clamp body.

The jaw post terminates at its lower end in a workpiece engaging pad.

The grab plate is movable between a position in which it grabs the jaw post, and a position in which it does not, by manual operation of a lever pivotally attached at one end thereof to the clamp body, to rotate a cam engageable with a portion of the grab plate.

Rotation of the cam is by at least one arcuate rack on the lever engaging a pinion associated with the cam.

The clamp body terminates in an arcuate array of serrations engageable by a thumb-release, spring-loaded pawl housed in an end of the lever distal from its pivot.

### Summary of a Second Aspect of the Invention

According to a third aspect of the invention, there is provided a mitre saw having a base, characterised in that the underside of the base is provided with formations for the attachment of legs.

### Advantages of the Second Aspect of the Invention

The provision of a leg attachment feature ensures that the mitre saw can always be located at waist height, irrespective of the presence or absence of a suitable support surface, and the need to make precision cuts at floor level is avoided.

### Preferred or Optional Features of the Second Aspect

In one embodiment, the legs are completely detachable from the base, for ease of transport or storage.

The legs comprise four individual legs, with the base carrying screw means whereby, with the formations of the base being sockets or spigots, the upper ends of the legs are engaged and the screw means operated to secure the upper ends of the legs to the base.

In an alternative embodiment, the legs are pivotably attached to the base and movable between a folded storage/transportation position, and an unfolded, deployed position.

### Summary of a Third Aspect of the Invention

According to a fifth aspect of the invention there is provided a mitre saw having a base, comprising a satellite stand which is detachable from the base and locatable by the user at a selected distance from the base suitable for supporting an end of a workpiece to be cut.

### Advantages of the Third Aspect of the Invention

As mitre saws are most frequently operated at floor level, the satellite stand provides a means of supporting long workpieces at a correct height to aid accurate cutting.

### Preferred or Optional Features of the Third Aspect

The satellite stand is a strap or clip fit to a portion of the base.

The satellite stand incorporates a roller on which an underside of a workpiece is adapted to bear.

### Summary of a Fourth Aspect of the Invention

According to a sixth aspect of the invention, there is provided a mitre saw having a base, with an end stop slidably attached to the base characterised in that the end stop has a rapid coarse positional adjustment feature, and also a fine positional adjustment feature.

### Advantages of the Fourth Aspect of the Invention

The features provide for rapid and accurate positioning of the end stop.

### Preferred or Optional Features of the Fourth Aspect

The end stop is slidably adjustable with respect to the base.

The end stop is capable of being slid inside the dimensional footprint of the base, thus permitting the cutting of workpieces that are shorter in length than the corresponding dimensions of the base.

The end stop is carried at one of a pair of parallel rods, one of which is provided along at least a portion of its length with formations, with a hand release catch biased into engagement with some of the deformations and releasable for rapid inward or outward movement of the stop with respect to the base.

The formations are a series of notches or indentations along one of the parallel rods.

The release catch is spring biased into engagement with some of the formations.

The release catch is connected to a trigger operable by the user when coarse positional adjustment of the end stop is required.

The fine adjustment is provided by a screw device and an associated, rotatable control knob enabling infinite, micro adjustment ensuring precision cutting.

The end stop is stowable.

### Summary of a Fifth Aspect of the Invention

According to a seventh aspect of the invention, of independent significance, there is provided a mitre saw comprising:

(i) a base unit;
(ii) a saw support assembly attachable to the base unit by a hand-operable, tool free connection; and
(iii) a saw assembly including an electric drive motor, which assembly is attachable to the saw support assembly by a hand-operable, tool free connection.

### Advantages of the Fifth Aspect of the Invention

By constructing a mitre saw of three basic components that may be readily assemble by hand, without the need for tools, provides the possibility of disassembly of a mitre saw, following factory setting, with the ergonomic stacking of the three basic components into a smaller volume area, such that the volume of a receiving carton can be reduced compared with the carton volume required for an assemble mitre saw with the result that, instead of an industry-standard pallet being capable of receiving six cartons only, some sixteen of the smaller volume cartons housing a disassembled mitre saw may be stacked on the same pallet, considerably reducing not only handling and shipping costs, but also the display shelf area required. In detail, a disassemble mitre saw in accordance with this aspect of the invention may be housed in a carton measuring 400 deep, 460 wide and 570 long, compared with the requirement for a carton measuring 470 deep 560 wide and 760 long for the equivalent mitre saw in a conventional, assembled state.

### Preferred or Optional Features of the Fifth Aspect

The tool-free connections comprise hand-operable screws.

The tool-free connections comprise hand-operable cam devices.

The tool-free connections comprise hand-operable over-centre devices.

### DRAWINGS

The accompanying drawings illustrate, by way of example only, a mitre saw incorporating the various aspects of the invention, in which:

FIG. 1A is a perspective view through a screwless clamp in accordance with the first aspect;

FIG. 1B is a longitudinal sectional view through the clamp of FIG. 1A;

FIG. 1C is a side elevation of the clamp of FIGS. 1B and 1C;

FIG. 1D is an end elevation of FIG. 1C;

FIG. 1E is a plan view of FIG. 1C;

FIG. 1F is an enlarged detail of the portion indicated of FIG. 1C;

FIG. 2A is a front perspective view of a mitre saw in accordance with the second aspect with the legs folded;

FIG. 2B corresponds to FIG. 2A but shows the legs partially deployed;

FIG. 2C corresponds to FIG. 2A but shows the legs fully deployed;

FIG. 2D shows how the mitre saw is employed;

FIG. 2E shows how a prior art mitre saw without legs is used, on site;

FIG. 3A is a front perspective view of a mitre saw in accordance with the third aspect, with a satellite stand attached to the base of the saw;

FIG. 3B corresponds to FIG. 3A but shows the satellite stand detached from the base;

FIG. 3C shows how a prior art mitre saw is used;

FIG. 4A shows a mitre saw in accordance with the fourth aspect, with an end stop deployed in an outer position;

FIG. 4B corresponds to FIG. 4A but shows the end stop used in an inner position;

FIG. 5A shows a prior art fully assembled mitre saw;

FIG. 5B, a container needed for the saw of 5A;

FIG. 5C, a maximum of six containers on any industry-standard pallet;

FIG. 5D, a knock-down mitre saw in accordance with the fifth aspect;

FIG. 5E, a container needed for the saw of FIG. 5D, and

FIG. 5F, the ability to load <16 containers of FIG. 5E onto the same, industry-standard pallet.

In all Figures, like components are accorded like reference numerals.

A mitre saw 1 comprises a base 2 adapted to seat on a bench or on the floor, a turntable 3, a support structure 4 incorporating slide bars 5 and carrying a support structure 6 for a circular blade 7 provided with a guard 8 driven by an electric motor within a housing 9 with an operator's handle 10 incorporating a trigger.

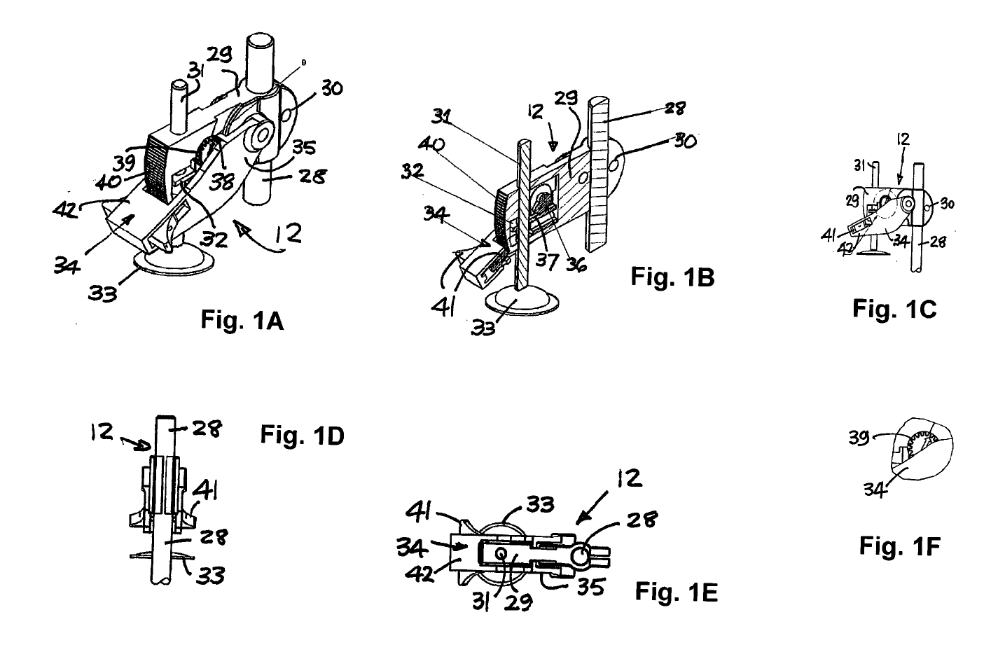

In accordance with the first aspect of the invention, show in FIGS. 1A-1F, the base 2 is provided with a screwless clamp 12 for a workpiece 13 in the form of a length or strip of timer or metal. Being screwless, the clamp 12 is quick acting and easy to use, which encourages its employment rather than the operator risking holding the workpiece 13 by hand. In detail, the clamp 12 comprises an upright support post 28 adapted to be located in a suitable aperture in a base of the saw 1. A clamp body 29 is connected in a user-adjustable position e.g. by means of a thumb screw passing through holes 30, on the support post 28 and extends laterally from the support post 28. Distal from the support post 28 an upright jaw post 31 passes through the clamp body 29 and also through a grab plate 32 housed within the clamp body 29. The jaw post 31 terminates at its lower end in a workpiece engaging pad 33. The grab plate 32 is movable between a position in which it grabs the jaw post 31, and a position in which it does not, by manual operation of a lever 34 pivotally attached at one end 35 thereof to the clamp body 29, to rotate a cam 36 engageable with a portion 37 of the grab plate 32. Rotation of the cam 36 is by at least one arcuate rack 38 on the lever 34 engaging a pinion 39 associated with the cam 36. The clamp body 29 terminates in an arcuate array of serrations 40 engageable by a thumb-release, spring-loaded pawl 41 housed in an end 42 of the lever 34 distal from its pivot.

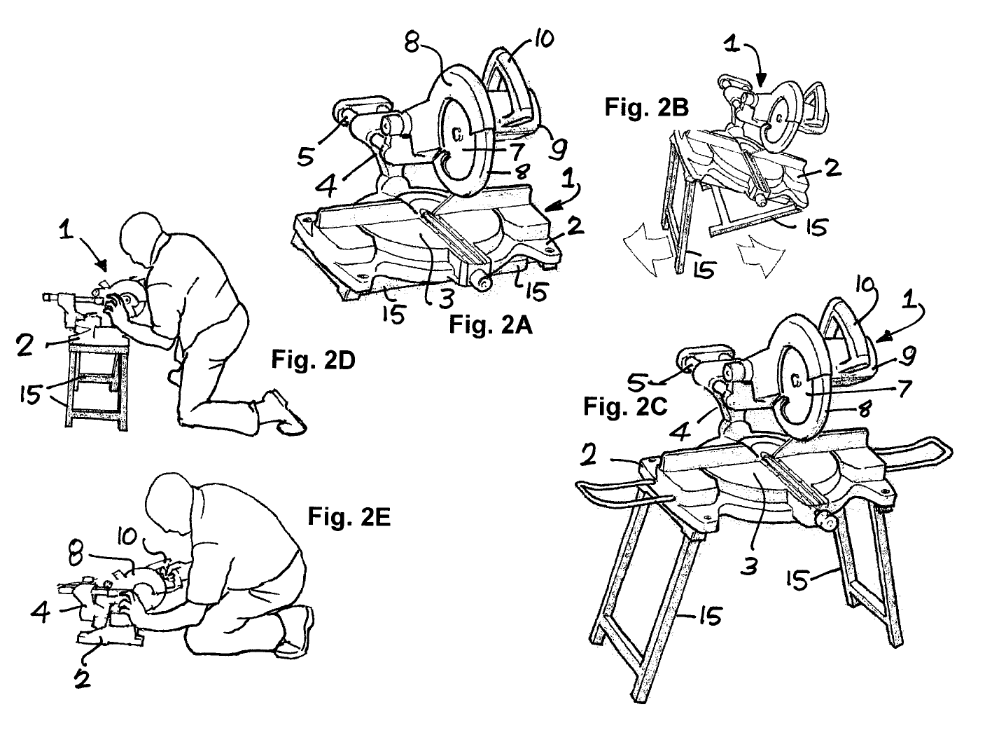

In accordance with the second aspect, shown in FIGS. 2A to 2E, the provision of a pair of foldable legs 15 hinged to opposite sides of the base 2 means that, if a bench is not available, as is frequently the case on a building site, then instead of the cramped use indicated in FIG. 2E when floor mounted, the user may readily deploy the legs to the position illustrated in FIG. 2C, for easier working, as indicated in FIG. 2D.

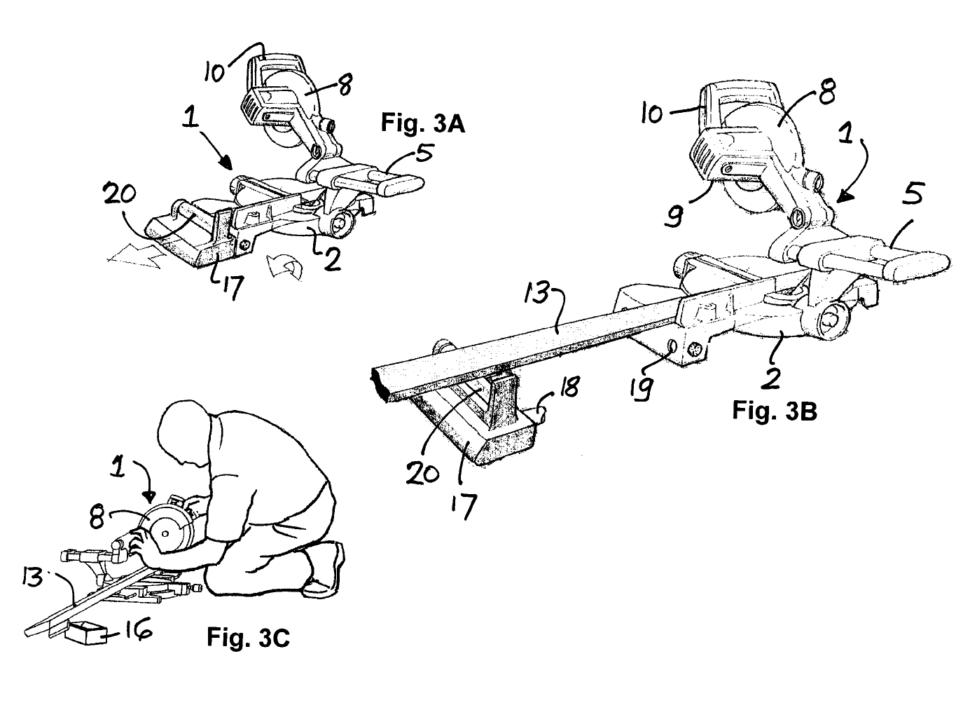

In accordance with the fourth embodiment, FIG. 3C indicates the standard procedure when working at floor level, of finding and using one or more housebricks 16 to support the distal end of the workpiece 13, but with the embodiment shown in FIGS. 3A and 3B, a stand 17 is clipped to the base 2 by a pair of pins 18 engaging apertures 19, ensures that a support stand 17 is readily available, and cutting operations need not be interrupted whilst the operator goes in search of housebricks. In addition, the provision of a freely rotatable roller 20 ensures that the workpiece may be readily advanced and retracted over the stand 17 as cutting operations progress.

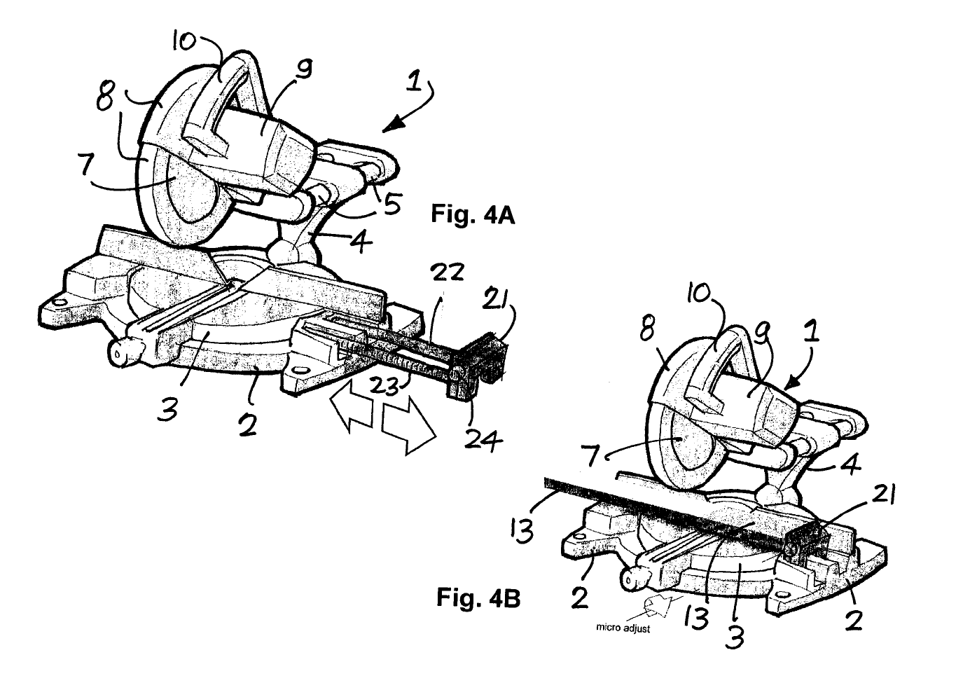

In the embodiment shown in FIGS. 4A and 4B, the saw is shown provided with a workpeice end stop 21 to assist in accurate cutting, the end stop being supported from the base 2 on a pair of extendable and retractable parallel rods 22, one of which is provided with regular ribs or apertures 23 engageable, for coarse adjustment by a releasable spring loaded plunger with fine positional adjustment then being provided by a screw device 24.

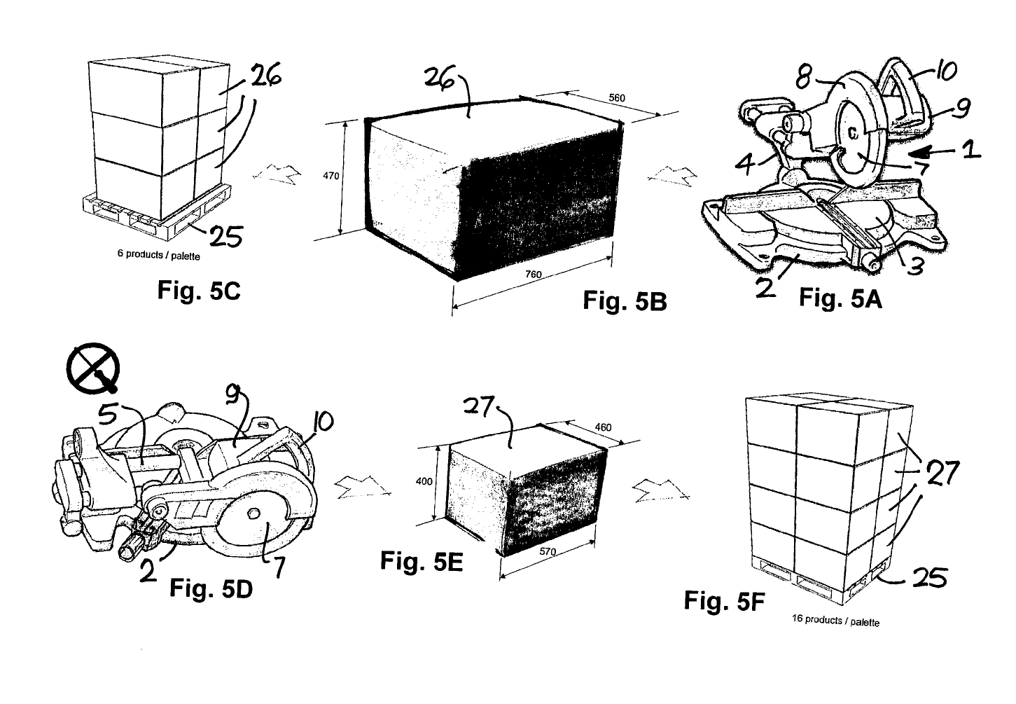

In the sixth embodiment shown in FIGS. 5A to 5F, the constraint in shipping a fully assembled mitre saw 1 on industry-standard pallets 25 can be appreciated from FIGS. 5A to 5C where boxes 26 of dimensions 470×560×760 are required for each saw 1, whereby six boxes are the maximum, with the pallets then loaded by fork-lift truck into a 40 ft container.

However, by providing for screwless re-assembly by the user (after setting up in the factory and disassembly in the factory for packaging to the position shown in FIG. 5D) it will be seen from FIG. 5E that much smaller 400×460×570 boxes 27 will suffice, to the extent that the same pallet 25 can accommodate sixteen boxes 27, thereby significantly increasing the number of saws 1, than can be loaded into a 40 ft container, hence considerably reducing shipping costs.

1-28. (canceled)

29. A mitre saw having a base, comprising a satellite stand which is detachable from the base and locatable by the user at a selected distance from the base suitable for supporting an end of a workpiece to be cut,

30. A mitre saw as claimed in claim 29, wherein the satellite stand is a snap or clip fit to a portion of the base.

31. A mitre saw as claimed in claim 29, wherein the satellite staid incorporates a roller on which an underside of a workpiece is adapted to bear.

32. A mitre saw having a base, with an end stop slidably attached to the base characterised in that the end stop has a rapid coarse positional adjustment feature, and also a fine positional adjustment feature.

33. A mitre saw as claimed in claim 32, wherein the end stop is slidably adjustable with respect to the base.

34. A mitre saw as claimed in claim 32, wherein the end stop is capable of being slid inside the dimensional footprint of the base, thus permitting the cutting of workpieces that are shorter in length than the corresponding dimensions of the base.

35. mitre saw as claimed in claim 32, wherein the end stop is carried at one of pair of parallel rods, one of which is provided along at least a portion of its length with formations, with a hand operable release catch biased into engagement with some of the formations and releasable for rapid inward or outward movement of the stop with respect to the base,

36. A mitre saw as claimed in claim 35, wherein, the formations are provided by a series of ribs or apertures along one of the parallel rods.

37. A mitre saw as claimed in claim 35, wherein the release catch is spring biased into engagement with some of the formations.

38. A mitre saw as claimed in claim 35, wherein the release catch is connected to a trigger operable by the hand of the user when coarse positional adjustment of the end stop is required.

39. A mitre saw as claimed in claim 32, wherein the fine positional adjustment is provided by a screw device and an associated, rotatable control knob enabling infinite, micro adjustment.

40. A mitre saw as claimed in claim 32, wherein the end stop is stowable.

41. A mitre saw having a base, characterised in that the underside of the base is provided with formations for the attachment of legs.

42. A mitre saw as claimed in claim 41, wherein the legs are completely detachable from the base, for ease of transport or storage.

43. A mitre saw as claimed in claim 41, wherein the legs comprise four individual legs, with screw means carried by the base whereby, with the formations of he base being sockets or spigots, the upper ends of the legs are engaged therewith and the screw means operated to secure the upper ends of the legs to the base.

44. A mitre saw as claimed in claim 41, wherein the legs are pivotably attached to the base and movable between a folded storage/transportation position, and an unfolded, deployed position.

45. A mitre saw boxed as three separated components, adapted to be assembled together by the user, without tools, the components comprising:
(i) a base;
(ii) a saw support structure attachable by the user to the base unit by a hand-operable, tool. free connection; and
(iii) a saw support structure, including an electric drive motor, which assembly is attachable by the user to the saw support structure by a hand-operable, tool free connection.

46. A mitre saw as claimed in claim 45, wherein the tool-free connections comprise hand-operable screws.
